(19) United States
(12) Patent Application Publication
(10) Pub. No.: US 2015/0365500 A1
(43) Pub. Date: Dec. 17, 2015

(54) REMOTE CLIENT APPLICATION

(71) Applicant: HEWLETT-PACKARD DEVELOPMENT COMPANY, L.P., Houston, TX (US)

(72) Inventors: Fletcher Liverance, Kent, OH (US); Matthew J. Kwiecinski, Wayne, PA (US); William C. Bredbenner, Wynnewood, PA (US)

(73) Assignee: Hewlett-Packard Development Company, L.P., Houston, TX (US)

(21) Appl. No.: 14/763,451

(22) PCT Filed: Jan. 31, 2013
(86) PCT No.: PCT/US2013/024026

§ 371 Date: Jul. 24, 2015

(51) Int. Cl. H04L 29/06; H04L 29/08

(52) U.S. Cl. CPC H04L 67/42; H04L 67/025

(57) ABSTRACT

An example method includes receiving input from a remote client (110) to launch an application; sending settings (124, 230) associated with the application to the remote client (110); and causing the application to be launched on the remote client (110) pursuant to the settings (124, 230).

### BACKGROUND

In current networks, such as enterprise networks that may communicate through both the world wide web (WWW) and local area networks (LAN), it is common to have a central database and/or one or more central servers. Various remote user devices, or remote clients, may access the central server in order to provide end-users with access to data and services available at or through the server.

### BRIEF DESCRIPTION OF THE DRAWINGS

For a more complete understanding of examples of the present disclosure, reference is now made to the following descriptions taken in connection with the accompanying drawings in which:

FIG. 1 is a schematic illustration of a system in accordance with one example;

FIG. 2 is a block diagram of an apparatus in accordance with an example;

FIG. 3 is a flow chart of an example process in accordance with an example; and

FIG. 4 is a screen shot in accordance with an example.

### DETAILED DESCRIPTION

In various examples disclosed herein, a request by a remote client to launch an application on a host server is directed to a shell application on the host server. The shell application causes the requested application to be launched on the remote client. Further, the shell application may use configuration data associated wall the requested application on the host server to be used in launching and running the application on the remote client.

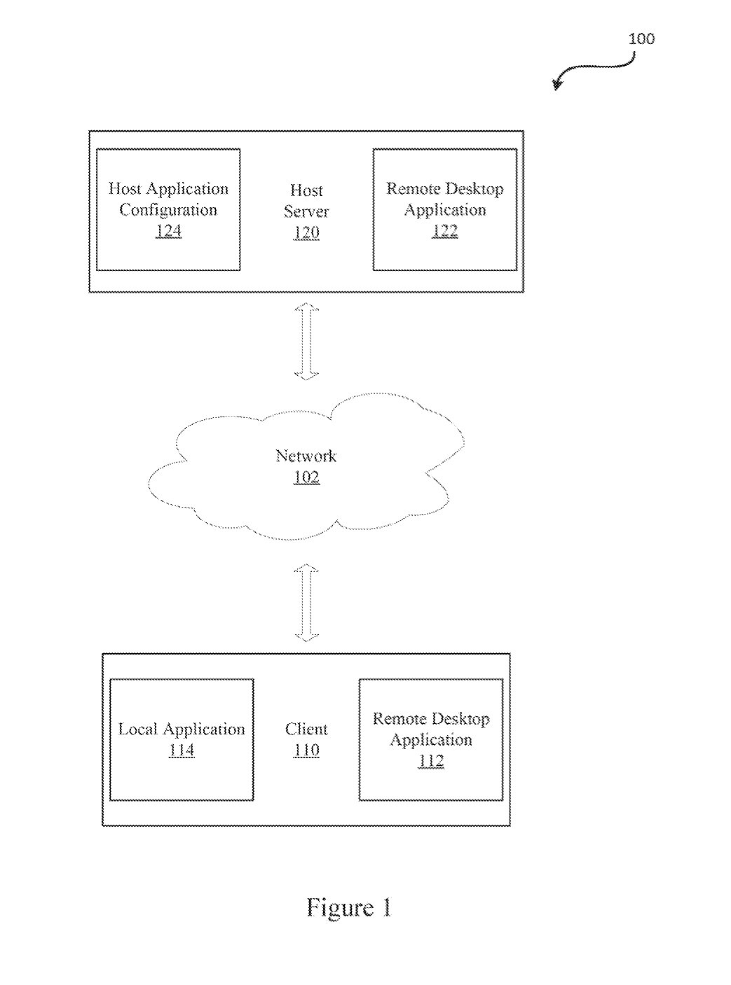

Referring now to FIG. 1, an example system 100 in accordance with one example is schematically illustrated. The system 100 may include various components, such as servers and terminals, which may be capable of implementing a remote connection, such as remote desktop protocol (RDP), for example. The example system 100 may be implemented within a network, such as an enterprise network (e.g., a virtual private network (VPN)) for a company having offices in multiple geographical locations, for example. In the illustrated example system 100, a client 110 may communicate with a host server 120 through a network 102.

In various examples, the system 100 may include one or more remote terminals, such as the client 110, from which end-users can access data and resources through the host server 120. In other examples, any number of clients may communicate with the host server 120 through the same or different networks, or through a direct connection with the host server 120.

In one example, the client 110 may be a terminal through which a user may form a remote desktop connection to the host server 120. Further, the client 110 may form a connection, through the host server 120, with other entities, such as other servers, other clients, databases or the like. In the example illustrated in FIG. 1, the client 110 may communicate with the host server 120 through a network 102. In some examples, the client 110 may be located in the same geographical location as the host server 120 and may communicate with the host server 120 through a local area network (LAN), such as a wideband local area network (WLAN). In other examples, the client 110 is remotely located from the host server 120 and may communicate with the host server 120 through a wide area network (WAN) which may be a public network, such as the Internet. As used herein, the term “client” or “remote client” may refer to any terminal that is separate from the host server 120 and communicates with the host server 120 through a connection, the connection being either a direct connection or through any network.

The remote client 110 illustrated in the example of FIG. 1 includes a remote desktop application 112 executing on, for example, a processor of the remote client 110. In various examples, the remote desktop application 112 allows the remote client 110 to communicate with the host server 120 and access various applications and/or data on or through the host server 120. Additionally, the remote client 110 may be provided with various applications, such as the local application 114 illustrated in FIG. 1, for execution by a processor of the remote client 110. The local application 114 may be a browser (e.g., Netscape, Internet Explorer, Mozilla, etc.), a word processor (e.g., Microsoft Word), a spreadsheet application (e.g., Excel) or any other such application.

The host server 120 may be coupled to various other components, such as a database storing data and/or applications, that may be accessed by various end-users within. The database may contain server-side resources, such as various application software programs, which may be pushed to a remote terminal computer in the network, for example. Additionally, remote desktop protocol (RDP) application software, which can be run by the host server 120 in order to allow connection by end-user devices (e.g., remote clients such as client 110) may be stored on the database and run by the host server 120.

In the example of FIG. 1, the host server 120 includes its own instance of a remote desktop application 122. The remote desktop application 122 of the host server 120 may allow remote clients, such as client 110, to access various data and/or applications on or through the host server 120. For example, various application hosted by the host server 120 and data available on a database connected to the host server 120 may be accessed by the remote client 110.

In various examples, the host server 120 may also be provided with a variety of applications for execution by a processor of the host server 120. As noted above with reference to the client 110, applications provided on the host server 120 may include, for example, a browser (e.g., Netscape, Internet Explorer, Mozilla, etc.), a word processor (e.g., Microsoft Word), a spreadsheet application (e.g., Excel) or any other such application. As illustrated in the example of FIG. 1, the host server 120 may also be provided with, or have access to, stored configuration data 124 related to the various applications. The configuration data 124 may be associated with configuration of the application when the application is launched on the server. For example, the configuration data 124 may include default settings for paper size, font, user identification and the like for a word processor. In another example, the configuration data 124 may include bookmarks (or favorites), as well as one or more home pages, for a browser application.

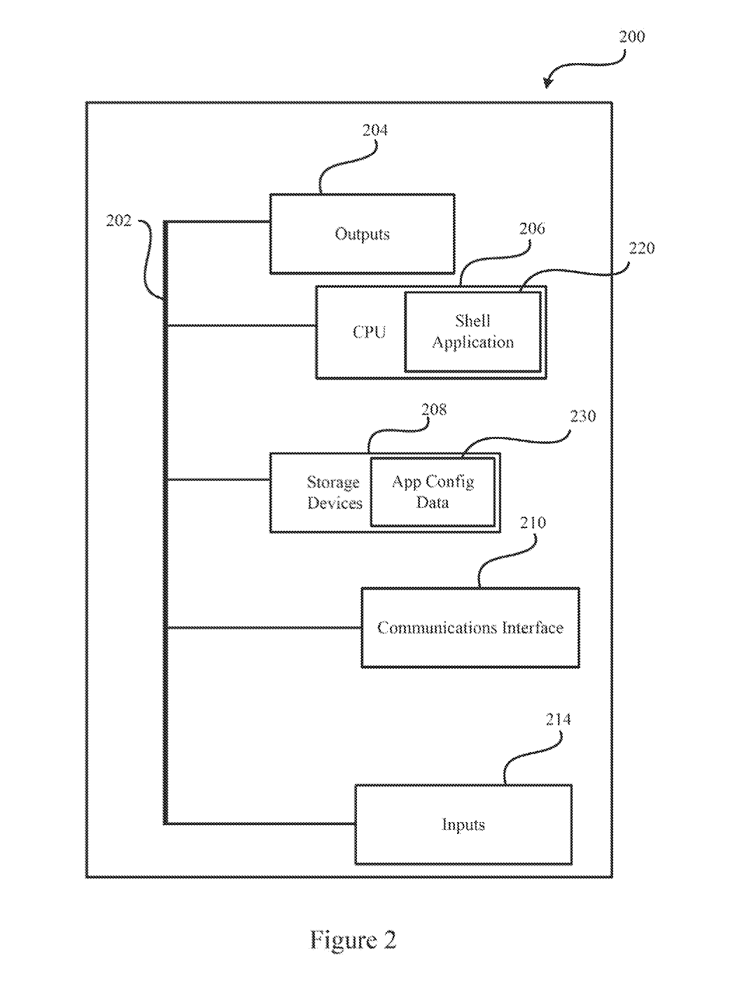

Referring now to FIG. 2, a block diagram of an apparatus 200 in accordance with an example is illustrated. The example apparatus 200 may be a computer system can be utilized as the host server 120 of FIG. 1. A similar apparatus may be used to illustrate an example client 110 of FIG. 1.

The apparatus 200 includes one or more outputs 204 such as a display for displaying a graphical user interlace (GUI), one or more input devices 214 such as a keyboard and/or mouse, one or more central processing units (CPUs) 206, one or more communications interfaces 210 such as a wireless interface or an Ethernet or other wired interface, and one or more storage devices 208 such as a computer-readable medium.

The storage devices 208 may include one or more memory devices, such as random access memory (RAM), read only memory (ROM), erasable programmable ROM (EPROM), electrically EPROM (EEPROM), flash memory, or any other non-volatile or volatile memory. The storage devices 208 may store code including instructions for execution by a processor (e.g., CPU 206). For example, the storage devices 208 may store an operating system (OS) of the apparatus 200 and one or more application software programs, such as the remote desktop protocol for the server or client. The various components may be coupled to each other through a system bus 202, for example.

The various components of the example apparatus 200 of FIG. 2 are not limited to those illustrated and may include any number of additional elements specific to the functions of that particular apparatus 200. For example, the apparatus 200 can also include a digital signal processor (DSP), additional memory elements and interfaces, an optical signal processor, one or more adapters configured to communicate information between the bus and an input device, output device or interface. The application programs can also include various software programs readable by one or more of the processors.

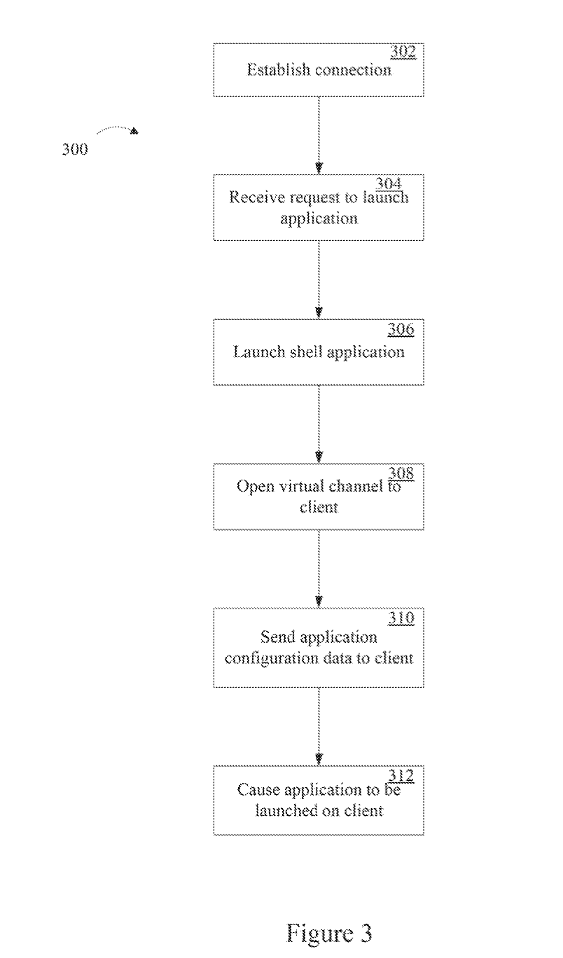

In various examples, the CPU 206 of the apparatus 200 (e.g., host server) may execute a shell application 220. As described in greater detail below with reference to FIG. 3, the shell application 220 may be configured to cause the launching of an application on the remote client (e.g., the client 110 of FIG. 1). For example, upon receiving a request from the remote client, through a remote desktop application, to launch an application on the server, the shell application 220 may redirect that request to the remote client. Thus, a copy of the requested application on the remote client may be launched to fulfill the request. Further, the shell application 220 may be configured to cause the remote client to use the application configuration data 230 (e.g., similar to the host application configuration data 124 of FIG. 1) in launching the application on the remote client.

Referring now to FIG. 3, a flow chart illustrates an example process 300 in accordance with an example. The example process 300 may be executed by the host server 120 of FIG. 1, for example. In the example process 300 of FIG. 3, a connection between a remote client and a host server is established (block 302). As noted above, the connection may be through a variety of arrangements, including a variety of networks, such as the Internet. The establishment of the connection may be performed in conjunction with, or be followed by, the execution of a remote desktop program, such as the Remote Desktop Protocol (RDP), using the remote desktop applications 112, 122 illustrated in FIG. 1, for example.

In various examples, during the remote desktop connection, a request may be received by the host server from the remote client to launch an application (block 304). The request may be received in various forms. In one example, a link to a website may be selected within the remote desktop window of the remote client. Selection of the link may result in a request to launch a browser application. In another example, the request may be in the form of an attempt to open a document using a word processor or another application.

In conventional arrangements, the application may be launched on the server, thus allowing a user on the remote client to use the application running on the host server through the remote desktop. However, this arrangement can result in significant inefficiencies. For example, in the case of a browser application, web pages may be sent to the server from a web host, rendered at the server, encoded by the remote desktop application on the server, sent to the remote client, and then decoded by the remote desktop application on the remote client.

Various examples of the present disclosure eliminate such inefficiencies. For example, in the example process 300 of FIG. 3, upon receipt of the request to launch the application, a shell application may be launched on the host server (block 306). In some examples, the shell application may be launched when the connection is initially established at, for example, block 302. In still other examples, the shell application may be always running on the server (e.g., in the background).

In various examples, the shell application is configured to process the request from the remote client to launch an application. However, instead of launching the application on the server, the shell application may cause the application to seamlessly launch on the remote client.

In this regard, the shell application may open a virtual channel between the host server and the remote client (block 308). In various examples, the virtual channel may be opened using the same communication path as used for the remote desktop connection. In some examples, the virtual channel is opened through a virtual private network (VPN) connection between the remote client and the host server.

The shell application may cause configuration data corresponding to the requested application to be sent from the host server to the remote client (block 310). In various examples, the configuration data is sent to the remote client through the virtual channel. As noted above, the configuration data may correspond to settings associated with the application when it is run on the host server. In various examples, the configuration data may include default settings for paper size, font, user identification, bookmarks (or favorites), one or more home pages or a variety of other settings, for example. In some examples, the configuration data is transmitted to the remote client for storage in, for example, as temporary memory. In other examples, the configuration data is maintained on the host server, but the configuration data is used by the shell application and/or the remote client for operation of the requested application, as described below.

In various examples, the application is then launched on the remote client (block 312). In launching the application on the remote client, the shell application on the host server may manage or control certain aspects of the application through, for example, the virtual channel. As noted above, the configuration data may be used to configure the application on the remote client. For example, in the case of a browser application, the home page shown upon launch of the browser application may be determined by the configuration data.

As noted above, in some examples, the configuration data is stored in a temporary memory of the remote client and is accessed during launch and operation of the requested application. In other examples, the configuration data is maintained on the host server. In such cases, the shell application may monitor and provide configuration data, as necessary, to the remote client to facilitate seamless launching and operation of the requested application.

In some examples, it may be desirable to maintain an appearance to the user of the remote client that the requested application is running within the remote desktop application. In this regard, the shell application may mimic operation of a conventional remote desktop application. For example, the requested browser application may be displayed within the remote desktop window, even though the actual application may be running outside the remote desktop environment. In various examples, the display of windows of the remote desktop application and the local application on the remote client may be coordinated by the shell application. In this regard, the shell application may control the display protocol of the remote desktop application and may, accordingly, seamlessly display the local application over the remote desktop window or vice versa. Thus, from a user's perspective, the remote desktop application window and the local application window may appear as a single window.

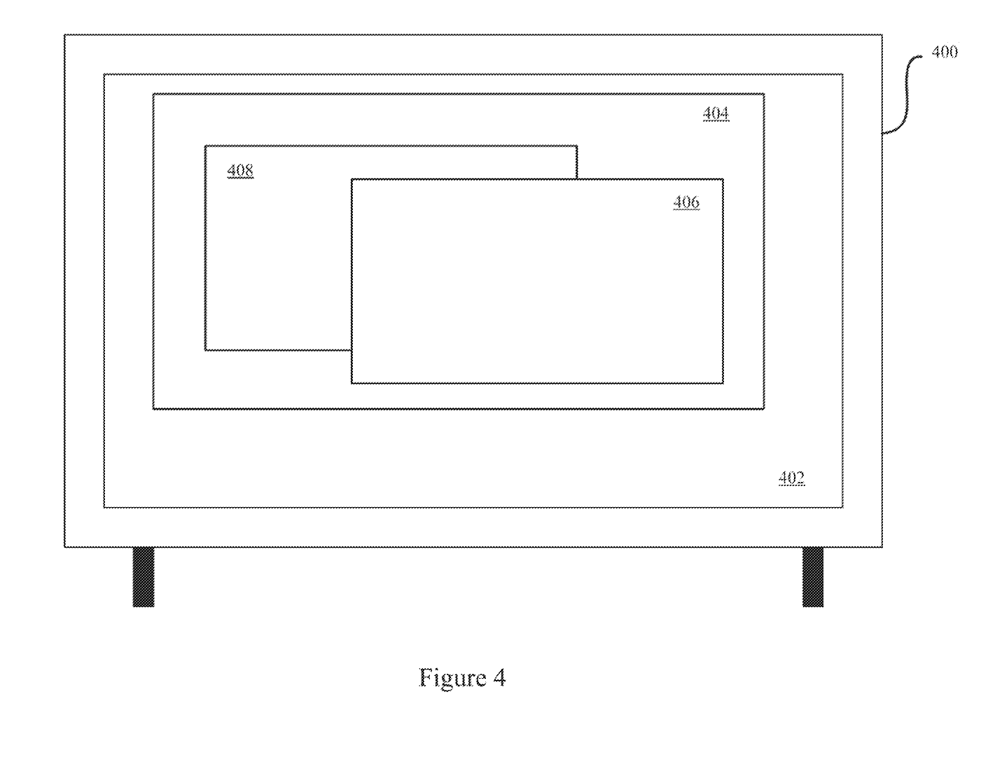

In this regard, reference may be made to FIG. 4, which illustrates a screen shot of a client device in accordance with an example. In the example of FIG. 4, as display 400 may provide a user of the client device with a local desktop 402. The local desktop 402 may include icons (not shown) corresponding to various applications. The local desktop 402 may further provide the user with one or more windows, each window corresponding to an application which may be running on the client device.

In the example of FIG. 1, the local desktop 402 includes a window 404 corresponding to a remote desktop application. In various examples, the remote desktop window 404 appears similar to the local desktop 402 and may include various icons. The remote desktop window 404 may further include sub-windows corresponding to applications which may be running on a host server and being accessed through the remote desktop application. In the example of FIG. 4, a sub-window 406 corresponding to an application (e.g., word processor) is displayed within the remote desktop window 404. In this regard, the sub-window 406 corresponds to an application running on the host server and accessed through the remote desktop application.

In accordance with various examples, as noted above, the display of windows of the remote desktop application and the local application on the remote client may be coordinated by the shell application. In the example of FIG. 4, a window 408 corresponding to an application running on the client device is illustrated. The application corresponding to the window 408 may be running on the client device pursuant to re-direction by the shell application described above. Thus, the shell application may control the display protocol of the remote desktop window 404 and the window 408. In providing as seamless display to the user, the shell application may draw the window 408 to appear as part of the remote desktop application. In this regard, as illustrated in FIG. 4, the window 408 corresponding to an application running on the client device may cover part of the remote desktop window 404, but may itself be covered by a sub-window 406 of the remote desktop window 404. Thus, the user of the remote desktop application may view the application corresponding to the window 408 as being a part of the remote desktop application.

Thus, an application requested within a remote desktop environment may be provided to the user of a remote client without the above-described inefficiencies associated with the remote desktop environment.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of various examples has been presented for purposes of illustration and description. The foregoing description is not intended to be exhaustive or limiting to the precise form disclosed, and modifications and variations are possible in light of the above teachings or may be acquired from practice of various examples. The examples discussed herein were chosen and described in order to explain the principles and the nature of various examples and its practical application to enable one skilled in the art to utilize the various examples and with various modifications as are suited to the particular use contemplated. The features of the examples described herein may be combined in all possible combinations of methods, apparatus, modules, systems, and computer program products.

What is claimed is:

1. An apparatus (120, 200), comprising:
a processor (206); and
a storage medium (208) having settings (124, 230) associated with one or more applications;
wherein the processor (206):
receives input from a remote client (110) to launch an application;
sends settings (124, 230) associated with the application to the remote client (110); and
causes the application to be launched on the remote client (110) pursuant to the settings.

2. The apparatus of claim 1, wherein the remote client (110) is a remote desktop client.

3. The apparatus of claim 1, wherein the processor (206) sends the settings (124, 230) through a virtual channel to the remote client (110).

4. The apparatus of claim 1, wherein the processor (206) controls display of the application on the remote client (110).

5. The apparatus of claim 4, wherein the processor (206) displays the application running on the remote client (110) in a window (404) corresponding to a remote desktop application (112, 122).

6. The apparatus of claim 1, wherein the settings (124, 230) include bookmarks associated with a browser application.

7. A method, comprising:
receiving input from a remote client (110) to launch an application;
sending settings (124, 230) associated with the application to the remote client (110); and
causing the application to be launched on the remote client (110) pursuant to the settings.

8. The method of claim 7, further comprising:
launching a shell application (220) for accessing and sending the settings (124, 230) to the remote client (110).

9. The method of claim 7, wherein the remote client (110) is a remote desktop client.

10. The method of claim 7, wherein sending the settings (124, 230) comprises:
opening a virtual channel to the remote client (110) for sending the settings (124, 230).

11. The method of claim 7, further comprising:
controlling display of the application on the remote client (110).

12. The method of claim 11, wherein controlling display of the application comprises:
displaying the application running on the remote client (110) in a window (404) corresponding to a remote desktop application (112, 122).

13. A computer program product, embodied on a non-transitory computer-readable medium, comprising:
computer code for sending input from a local client (110) to a host server (120) to launch an application;
computer code for receiving, at the local client (110), settings (124, 230) associated with the application from the host server (120); and
computer code for launching the application at the local client (110) pursuant to the settings (124, 230).

14. The computer program product of claim 13, wherein the host server (120) is a host for a remote desktop client.

15. The computer program product of claim 13, wherein the application is displayed in a window (404) corresponding to a remote desktop application (112, 122).
